(19) United States
(12) Patent Application Publication
(10) Pub. No.: US 2010/0094733 A1
(43) Pub. Date: Apr. 15, 2010

(54) SYSTEM AND METHOD FOR INCENTIVIZING THE PURCHASE OF RETAIL PRODUCTS

(76) Inventors: David S. Shapira, Pittsburgh, PA (US); John Lucot, Pittsburgh, PA (US)

Correspondence Address: ECKERT SEAMANS CHERIN & MELLOTT, 600 GRANT STREET, 44TH FLOOR, PITTSBURGH, PA, 15219, US

(21) Appl. No.: 12/423,089

(22) Filed: Apr. 14, 2009

Related U.S. Application Data
(60) Provisional application No. 61/105,233, filed on Oct. 14, 2008.

(51) Int. Cl. G06Q 30/00; G06Q 10/00; G06Q 50/00; G06Q 20/00

(52) U.S. Cl. 705/30; 705/21; 705/14.28

(57) ABSTRACT

A method of incentivizing the purchase of products from a retailer includes receiving customer identification information when a customer purchases a number of gallons of gasoline, determining updated accumulated discount information and updated accumulated gallons information (gallons not yet converted to a discount) in response thereto, and storing the updated accumulated discount information and the updated accumulated gallons information at a central location in association with the customer identification information. Furthermore, the method includes receiving the customer identification information when that customer purchases retail products, determining an available discount based on the earned discount level, determining from the customer whether the customer elects to use the available discount, and if so, applying the available percentage discount in connection with the purchase of retail products by the customer.

### CROSS-REFERENCE TO RELATED APPLICATIONS

This application claims the benefit of U.S. Provisional Application No. 61/105,233, entitled “System and Method for Incentivizing the Purchase of Retail Products,” which was filed on Oct. 14, 2008, the disclosure of which is incorporated herein by reference.

### FIELD OF THE INVENTION

The present invention relates to the sale of retail products, and in particular to a system and method for providing incentives to new and existing customers to purchase the products of a retailer by purchasing gasoline from a gas station affiliated with the retailer.

### BACKGROUND OF THE INVENTION

Many retailers, such as supermarkets, discount stores, warehouse stores or clubs, convenience stores and the like, have programs in which customers are provided with cards, sometimes referred to as frequent shopper cards or loyalty cards, which enable the customers to receive discounts on selected products or other awards if the card is presented (and typically scanned) at the time of purchase. Such cards typically have customer identifying information encoded thereon, such as in the form of an optically readable bar code or some other machine readable form, which link the customer and the card to a particular account and/or record associated with the customer. Many such retailers, in addition to offering their traditional products (e.g., food and household items), also sell gasoline. Furthermore, retailers are always looking for ways to increase the volume of sales in their stores. In other words, such retailers are always seeking ways to incentivize new and existing customers to purchase their products.

### SUMMARY OF THE INVENTION

In one embodiment, a method of incentivizing the purchase of products from a retailer is provided. The method includes receiving customer identification information associated with a customer when the customer purchases a number of gallons of gasoline at a gas station location affiliated with the retailer and determining updated accumulated discount information and updated accumulated gallons information in response to receiving the customer identification information. The updated accumulated discount information includes a percentage discount value and the accumulated gallons information includes a number of gallons purchased by the customer but not yet converted into a discount. The step of determining the updated accumulated discount information and the updated accumulated gallons information is based on the number of gallons that is purchased by the customer, the then existing accumulated discount information and the then existing accumulated gallons information that is stored for the customer at a central location in association with the customer's customer identification number, and a predetermined number of gallons of gasoline that is required to be purchased for earning a particular level of discount, such as a one percent (1%) discount. The method further includes storing the updated accumulated discount information and the updated accumulated gallons information at the central location in association with the customer identification information. Furthermore, the method includes receiving the customer identification information associated with the customer when that customer purchases retail products at a retailer location of the retailer, determining an available percentage discount based on the updated accumulated discount information using the customer identification information associated with the customer, determining from the customer whether the customer elects to use the available percentage discount, and if it is determined that the customer wishes to use the available discount, applying the available percentage discount in connection with the purchase of retail products by the customer.

In another embodiment, a system is provided for incentivizing a customer to purchase products from a retailer, wherein the customer has customer identification information associated therewith. The system includes a main server and a customer database in electronic communication with the main server. The customer database stores accumulated discount information and accumulated gallons information for the customer in association with the customer's customer identification information. The accumulated discount information and the accumulated gallons information are determined (updated) each time the customer purchases a number of gallons of gasoline at a gas station location affiliated with the retailer and the customer identification information is obtained in association therewith. The accumulated discount information is a percentage discount and the accumulated gallons information is a number of gallons purchased but not yet converted into a discount. The accumulated discount information and the accumulated gallons information, when determined, is based on the number of gallons purchased, existing accumulated discount information and existing accumulated gallons information stored in the customer database in association with the customer identification information, and a predetermined number of gallons required for earning a particular level of discount. The system further includes at least one computing device located at a retailer location of the retailer that is adapted to receive the customer identification information associated with the customer when the customer purchases retail products at the retailer location, obtain an available percentage discount based on the updated accumulated discount information using the customer identification information associated with the customer, after the available percentage discount is obtained determine from the customer whether the customer elects to use the available percentage discount, and if it is determined from the customer that the customer elects to use the available percentage discount, apply the available percentage discount in connection with the purchase of retail products by the customer.

Therefore, it should now be apparent that the invention substantially achieves all the above aspects and advantages. Additional aspects and advantages of the invention will be set forth in the description that follows, and in part will be apparent from the description, or may be learned by practice of the invention. The aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a block diagram of a system for incentivizing new and existing customers to purchase the products of a retailer according to one embodiment of the present invention;

FIG. 2 is a flowchart illustrating a method according to one embodiment wherein customers are able to earn discounts on the future purchase of retail products based on the purchase of gasoline; and

FIG. 3 is a flowchart showing a method according to one embodiment wherein customers are able to redeem discounts earned in the manner shown in FIG. 2.

### DESCRIPTION OF THE PREFERRED EMBODIMENTS

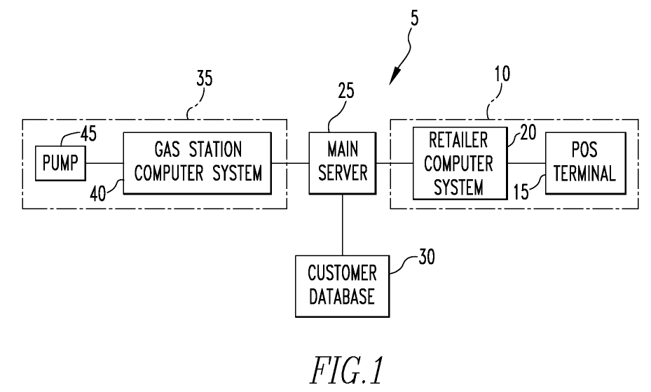

FIG. 1 is a block diagram of a system 5 for incentivizing new and existing customers to purchase the products of a retailer according to one embodiment of the present invention. As seen in FIG. 1, the system 5 includes a retailer location 10, such as a supermarket, convenience store or the like. At least one point-of-sale (POS) terminal 15 and a retailer computer system 20 are located at the retailer location 10 for enabling customers to purchase the products of the retailer at the retailer location 10. The point-of-sale terminal 15 is a computerized device that is, among other things, able to read encoded, machine readable information, such as a bar code (e.g., UPC symbol) or RFID tag, provided on products and other items. In addition, the point-of-sale terminal 15 is also able to receive customer identification information, preferably by obtaining the customer identification information from an associated customer identification element as described herein. For example, the point-of-sale terminal 15 may be able to read bar coded or other machine-readable customer identification information from a customer card issued to the retailer's customers. By way of example, the point-of-sale terminal 15 may be a cash register system that is commonly found in supermarkets.

The point-of-sale terminal 15 is in electronic communication with the retailer computer system 20 to enable information received by the point-of-sale terminal 15 to be sent to the retailer computer system 20. The retailer computer system 20 may be any type of general purpose computing device such as a personal computer (PC), a server computer, or a PC in communication with a server computer. The retailer computer system 20 is provided with software that enables it to process and facilitate purchases being made by the retailer's customers and to perform the steps of the present invention as described herein. A suitable example of such software is the IBM ACE POS system that is customized and configured according to the present invention.

The system 5 also includes a main server 25, preferably located in a centralized location remote from the retailer location 10. The main server 25 is preferably a server computer provided with a software application that enables the retailer to implement a customer loyalty program wherein customers are assigned an account with associated customer identification information for identifying the customer (such as, for example, a unique ID number). Under the program, customers are able to earn rewards and discounts based on purchases or other activities. The software application also enables the retailer to collect important customer related data for use in, for example, marketing efforts. One suitable example of such a software application is the IBM Electronic Marketing Enterprise (EME) Solution. Preferably, although not necessarily, each customer has or is provided with a customer identification element that has the customer identification information for identifying the customer associated therewith, such as information provided thereon in machine readable form like bar code form. The main server 25 is in electronic communication with a customer database 30, which stores data relating to the customers of the retailer that is collected by the main server 25, including the discount related information of the present invention that is described herein.

As seen in FIG. 1, the system 5 further includes a gas station location 35. The gas station location 35 is preferably a gas station owned and/or operated by the retailer described above. Such a gas station may be located adjacent to retailer location 10 (outside and close to a main store), or may be part of a convenience store owned and/or operated by the retailer. Alternatively, the gas station location 35 may be a remotely located gas station owned and/or operated by the retailer or another entity that is affiliated with the retailer (for example, by way of a contractual arrangement with the retailer) for purposes of the operation of the system 5. A gas station computer system 40 and a gasoline pump 45 are located at the gas station location 35.

The gas station computer system 40 may be any type of general purpose computing device such as a PC, a server computer or a PC in communication with a server computer. In addition, the gas station computer system 40 is in electronic communication with both the main server 25 and the gasoline pump 45 to enable data and commands to be exchanged therebetween. The gasoline pump 45 is preferably a conventional gasoline pump that includes a computing device, such as a microprocessor or controller, for controlling the operation thereof. The gasoline pump 45 is adapted to receive customer identification information as described above in connection with the purchase of gasoline. In the preferred embodiment, the gasoline pump 45 includes a reading device, such as a bar code reader, capable of reading customer identification information associated with customer identification elements, such as bar coded customer identification information encoded on a customer card, as described above. The gas station computer system 40 includes software, such as a known POS software system, for processing and facilitating the purchase of gasoline and other items at the gas station location 35 that is customized and configured to perform the steps of the present invention as described herein.

Although only a single point-of-sale terminal 15 and a single retailer location 10 are shown in FIG. 1, it will be appreciated that multiple point-of-sale terminals 15 may be connected to the retailer computer system 20 and that multiple retailer locations 10 each having a retailer computer system 20 connected to one or more point-of-sale terminals 15 and the main server 25 may be provided without departing from the scope of the present invention. As such, a customer may shop at any one of multiple retailer locations 20 and take advantage of earned discounts as described herein based on the information that is stored in the customer database 30. Similarly, multiple gas station locations 35 each having a gas station computer system 40 connected to multiple pumps 45 and to the main server 25 may be provided without departing from the scope of the present invention so that customers can earn discounts as described herein at multiple locations. Furthermore, as will be appreciated, in certain situations the retailer computer system 20 and the gas station computer system 40 may be the same device. For example, in the case of a retail store, such as a convenience store or a supermarket, having a gas station, the retailer location 10 and the gas station location 35 may be one and the same and the retailer computer system 20 and the gas station computer 40 may be one and the same, wherein a customer may, as described in greater detail below, purchase gasoline and thereby earn a discount and then redeem the discount at the same location.

The system 5 contemplates that the retailer in question has implemented a program wherein customers may earn discounts and rewards in association with customer identifying information. In the preferred embodiment, each customer has or is provided with one or more customer identification elements that each have customer identification information associated therewith. As used herein, the term customer identification element refers to any device, component, part, piece of information or other means having customer identification information associated therewith that enables the customer to be identified by the retailer in question. Examples of customer identification elements include, without limitation, a customer card having customer identification information provided thereon in bar code or magnetically encoded form, a key fob device, an RFID tag, a credit card or debit card (having the account number linked with the customer identifying information), a phone number, a social security number, a password, or even the customer's fingerprint or retina that may be scanned and read by an appropriate device and matched with an associated customer ID number or the like that is used to identify the customer. In the preferred embodiment of the present invention, the customer identification elements used are customer cards having customer identification information provided thereon. For convenience and ease of description, that type of customer identification element will be used in the following description. However, it will be appreciated that other types of customer identification elements, alone or in combination, may be used and substituted for the customer cards without departing from the scope of the present invention.

According to an aspect of the invention, in order to provide an incentive to customers to purchase retail goods from the retailer, customers are able to earn discounts on the purchase of retail products at the retailer location 10 based on the purchase of gasoline at the gas station location 35. In particular, in the preferred embodiment, a customer will earn a certain percentage discount on a subsequent purchase of retail goods from the retailer operating the retailer location 10 each time a predetermined number of gallons of gasoline is purchased by the customer at the gas station location 35. The discounts will be stored and accumulated (until used) in a record maintained by the customer database 30 in association with the customer's customer identification information (referred to herein as “accumulated discount information”). For example, a customer may earn a one percent (1%) discount for every ten (10) gallons of gasoline that are purchased. Thus, if the customer purchases thirty (30) gallons of gasoline at the gas station location 35 in one or more transactions (before redeeming a discount), the customer will have earned a three percent (3%) discount on a subsequent purchase of retail goods.

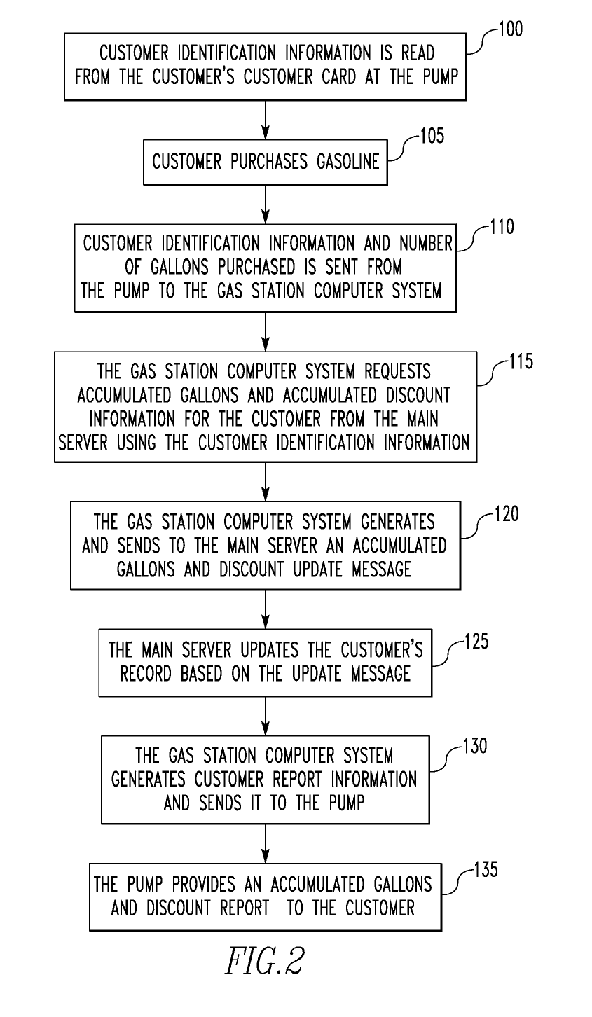

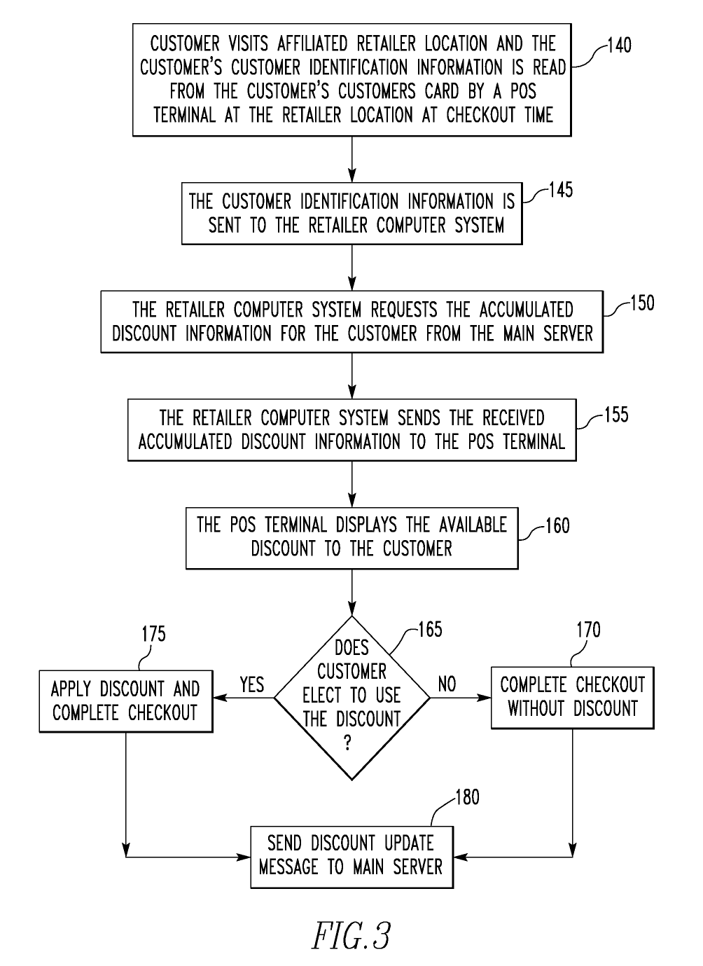

In addition, the system 5 will also keep track of the number of gallons purchased that have not yet been converted into a discount because the total amount has not yet reached the predetermined discount earning level (referred to herein as “accumulated gallons information”) and will add to that amount in a subsequent transition or transactions until enough gasoline has been purchased to earn a discount. For example, if a customer starting with no discount purchases thirteen (13) gallons of gasoline on one day, the customer's accumulated discount information will be updated to equal one percent (1%) and the customer's accumulated gallons information will be updated to equal three (3) gallons. If the customer then, without redeeming the discount, purchases nineteen (19) gallons of gasoline on a subsequent day, the customer's accumulated discount information will be updated to equal three percent (3%) (the customer earned an additional two percent (2%) discount because with that purchase a total of twenty-two (22) unconverted gallons had been purchased) and the customer's accumulated gallons information will be updated to be two (2) gallons (of the twenty-two (22) unconverted gallons, twenty (20) gallons are converted to the additional two percent (2%) discount, leaving two (2) gallons remaining). This process will continue as just described with each gasoline purchase. In addition, each time that a customer decides to redeem his or her stored and accumulated discount when purchasing retail goods, the accumulated discount information for the customer will be updated accordingly to reflect the fact that the discount has been used. One particular method of implementing such a system (i.e., awarding and accumulating discounts and redeeming discounts on demand) according to one particular embodiment of the invention is shown in FIGS. 2 and 3 and is described in greater detail below.

Referring to FIG. 2, a flowchart is provided that illustrates a method according to an aspect of the present invention wherein customers earn discounts on the purchase of retail products at the retailer location 10 based on the purchase of gasoline at the gas station location 35. The method begins at step 100, where a customer visits the gas station location 35 in order to purchase gasoline. At that time, the customer identification information associated with the customer is read from the customer's customer card at the pump 45. In the preferred embodiment, the customer identification information is a unique customer identification number that is provided in barcode form on the customer's customer card. That barcode is read by a barcode reader provided as part of the pump 45. Next, at step 105, the customer purchases a certain number of gallons of gasoline at the pump 45. Then, at step 110, the customer identification information that was read at step 100 and the number of gallons that were purchased is sent from the pump 45 to the gas station computer system 40.

At step 115, the gas station computer system 40 requests the current accumulated gallons and accumulated discount information for the customer that is stored in the customer database 30 from the main server 25 using the customer identification information obtained in step 100. Upon receipt of the accumulated gallons and accumulated discount information from the main server 25, the gas station computer system 40 will, at step 120, generate an accumulated gallons and discount update message and send that message to the main server 25. In particular, the gas station computer system 40 will determine what the new accumulated gallons amount and the new accumulated discount level for the customer should be following the current purchase of gasoline based upon: (i) the number of gallons that were purchased (that information is received in step 110), (ii) the number of gallons required to earn a discount, and (iii) the current accumulated gallons and accumulated discount information that was received. For example, if at step 105 a customer purchases fifteen (15) gallons of gasoline, if customers earn a one percent (1%) discount for every ten (10) gallons of gasoline purchased, and if in response to step 115 the gas station computer system 40 receives accumulated gallons information equal to four (4) gallons and accumulated discount information equal to two percent (2%), then the gas station computer system 40 will, at step 120, generate an update message that indicates that the new accumulated gallons amount should be nine (9) gallons and the new accumulated discount level should be three percent (3%) (fifteen (15) new gallons plus four (4) accumulated gallons is a total of nineteen (19) accumulated gallons; ten (10) of those accumulated gallons will be converted to a one percent (1%) discount, with nine (9) accumulated gallons being left over; the additional one percent (1%) discount is added to the two percent (2%) accumulated discount). Next, at step 125, the main server 25, upon receiving the accumulated gallons and discount update message from the gas station computer system 40, updates the customer's record in the customer database 30 based upon the update message. Specifically, the main server 25 will cause the current accumulated gallons and current accumulated discount information stored in the database 30 in association with the customer's customer identification information to be changed to the new amounts reflected in the update message. Following the example given above, the two percent (2%) accumulated discount information will be changed to three percent (3%) and the four (4) gallon accumulated gallons information will be changed to nine (9) gallons.

Next, at step 130, the gas station computer system 40 generates customer report information and sends that information to the pump 45. Specifically, the customer report information will reflect the current accumulated gallons information and the current accumulated discount information for the customer (i.e., the values reflected in the update message). At step 135, the pump 45 will provide an accumulated gallons and discount report to the customer so that the customer will be aware of the then current values. Preferably, the report is provided in the form of a receipt printed by the pump 45. Other methods of providing the report may be used in addition to or instead of the receipt. For example, the appropriate information may be displayed on a display provided as part of the pump 45 and/or provided in the form of an audio announcement by the pump 45.

Thus, the steps shown in FIG. 2 will result in the customer's accumulated gallons and accumulated discount information stored in the customer database 30 being updated each time that the customer purchases gasoline at the gas station location 35.

FIG. 3 is a flowchart that illustrates a method according to one embodiment of the invention wherein customers are able to redeem their earned discounts in connection with the purchase of retail products, such as groceries, from the retailer at the retailer location 10. The method begins at step 140, wherein the customer visits the retailer location 10 for the purpose of purchasing retail products. At checkout time, the customer's customer identification information is read from the customer's customer card by the point-of-sale terminal 15 using, for example, a barcode reader provided as a part thereof. Next, at step 145, the customer identification information is sent to the retailer computer system 20 by the point-of-sale terminal 15. Then, at step 150, the retailer computer system 20 requests the accumulated discount information for the customer from the main server 25 using the customer's customer identification information. In response to that request, the main server 25 will obtain the customer's accumulated discount information that is stored in the customer database 30 in association with the customer's customer identification information. At step 155, in response to receiving the accumulated discount information from the main server 25, the retailer computer system 20 sends the received accumulated discount information to the point-of-sale terminal 15. Next, at step 160, the point-of-sale terminal 15 provides the available percentage discount to the customer, preferably by displaying it on a display provided as part of the point-of-sale terminal 15. In this embodiment, the available percentage discount is the level that is specified in the accumulated discount information.

At step 165, a determination is then made as to whether the customer has elected to use the discount. For example, the customer may be queried in this manner on a display forming a part of the point-of-sale terminal 15 and may provide an answer using an input device, such as a keypad, provided as part of the point-of-sale terminal 15. Alternatively, the customer may be asked verbally by an employee of the retailer, such as a cashier, that is operating the point-of-sale terminal 15 whether they wish to use their discount. If the answer at step 165 is no, meaning that the customer has elected not to use their available discount, then, at step 170, the checkout process is completed without any discount being applied. For example, a customer may elect not to take an available percentage discount when the current purchase is small, preferring to save the discount for use at a later time when the purchase amount is more substantial. If, however, at step 165 the answer is yes, meaning that the customer has elected to use their available discount, then, at step 175, the available percentage discount is applied to the customer's total for the current purchases and the checkout process is completed based upon the discounted amount. In one particular embodiment, the size of the purchase (i.e., to total dollar amount) to which the percentage discount may be applied is limited. For example, a particular retailer may allow the available discount percentage to be applied to only the first $300 of a transaction, with the remainder of the transaction (i.e., anything above $300) not having a discount applied thereto.

Following either step 170 or 175, as appropriate, the retailer computer system 20, at step 180, sends an update message to the main server 25 which indicates whether or not the customer has used their available discount. In the case where the customer has used the available discount (step 175), the main server 25 will then update the customer's record in the customer database to reflect that the discount has been used. Specifically, in the present embodiment, the accumulated discount information stored in the customer database 30 will be reset to zero.

According to an alternative embodiment, the method of FIG. 3 may further include steps wherein if the customer elects to use the available discount, the customer may specify a portion of the discount that is to be used in that transaction, with the remainder of the discount being saved for later use. For example, if the customer has a five percent (5%) discount available, the customer may specify through the point-of-sale terminal 15 that only one percent (1%) of the discount is to be used in the current transaction, with the remaining four percent (4%) discount to be saved for later use. In such as case, step 180 will result in the accumulated discount information for that customer stored within the customer database 30 being changed to the unused value (in this example, four percent (4%)).

In addition, in the preferred embodiment, a customer is able to accumulate more than a one hundred percent (100%) discount (e.g., one hundred twenty percent (120%)) through gasoline purchases made at the gas station location 35. However, the customer is only able to use (redeem) up to a one hundred percent (100%) discount, as described herein, in any single transaction at the retailer location 10. Any unused portion of the accumulated discount will be saved for later use and/or further accumulation of additional discount values. For example, if a customer has accumulated a one hundred twenty percent (120%) discount (stored in the customer database 30), the customer may use a one hundred percent (100%) discount in a single transaction (perhaps with the total dollar amount of the purchase being limited as described above), and the remaining twenty percent (20%) will be stored in the customer database 30 for later use and/or further accumulation of additional discount levels. In this embodiment, the available discount that is displayed to the customer in step 160 will be the discount that is actually available for use in the current transaction (e.g., a one hundred percent (100%) discount rather than a one hundred twenty percent (120%) discount).

In another particular, alternative embodiment, the discount amount that may be used for any single transaction is capped. In other words, in this embodiment, in any single transaction at the retailer location 10, the customer is only able to use (redeem) up to a certain predetermined discount amount (i.e., a predetermined percentage discount level, such as a twenty percent (20%) discount) during that transaction. Any unused portion of the customer's total accumulated discount will be stored in the customer database 30 for later use (in later transactions) and/or further accumulation of additional discount values. For example, if a customer has accumulated a sixty percent (60%) discount, the customer will only be able to use a twenty percent (20%) discount during a particular transaction at the retailer location 10, and the remaining forty percent (40%) discount of the customer will be stored in the customer database 30 (i.e., the accumulated discount information stored in the customer database 30 will be reset to forty percent (40%)) for later use and/or further accumulation of additional discount values. In this embodiment, the available discount that is displayed to the customer in step 160 will be the discount that is actually available for use in the current transaction (e.g., a twenty percent (20%) discount rather than a sixty percent (60%) discount).

Thus, FIG. 3 illustrates a method wherein using only the customer's customer identification information, the customer may redeem discounts in connection with the purchase of retail products at the retailer location 10, wherein the discounts were earned based upon the purchase of gasoline at the gas station location 35.

As will be appreciated, the combination of the methods shown in FIGS. 2 and 3 will incentivize customers to purchase retail products at the retailer location 10 in order to take advantage of the discounts they have earned in connection with their gasoline purchases at the gas station location 35.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. For example, in the particular embodiments described above, the discounts that are earned as a result of purchasing gasoline at the gas station location 35 are in the form of percentage discounts on the future purchase of retail products at the retailer location 10. It should be understood that other types of discounts are also possible. For example, the discounts that are earned as a result of purchasing gasoline at the gas station location 35 may be in the form of a particular flat dollar amount (e.g., one dollar ($1) for every ten (10) gallons of gasoline that are purchased) or a particular free product (e.g., a free box of cereal). Accordingly, the invention is not to be considered as limited by the foregoing description but is only limited by the scope of the appended claims.

What is claimed is:

1. A method of incentivizing the purchase of products from a retailer, comprising:
receiving customer identification information associated with a customer when said customer purchases a number of gallons of gasoline at a gas station location affiliated with said retailer;
determining updated accumulated discount information and updated accumulated gallons information in response to the receiving, said updated accumulated discount information comprising a percentage discount and said updated accumulated gallons information comprising a number of gallons purchased but not yet converted into a discount, wherein said determining is based on said number of gallons purchased, existing accumulated discount information and existing accumulated gallons information stored at a central location in association with said customer identification information, and a predetermined number of gallons required for earning a particular level of discount;
storing said updated accumulated discount information and said updated accumulated gallons information at said central location in association with said customer identification information;
receiving said customer identification information associated with said customer when said customer purchases retail products at a retailer location of said retailer;
determining an available percentage discount based on said updated accumulated discount information using said customer identification information associated with said customer;
in response to and following said determining an available percentage discount, determining from said customer whether said customer elects to use said available percentage discount; and
if it is determined from said customer that said customer elects to use said available percentage discount, applying said available percentage discount in connection with said purchase of retail products by said customer.

2. The method according to claim 1, wherein said determining an available percentage comprises obtaining said updated accumulated discount information from said central location using said customer identification information associated with said customer and determining said available percentage discount based on the obtained updated accumulated discount information.

3. The method according to claim 1, wherein said applying said available percentage discount in connection with said purchase of retail products by said customer comprises applying said available percentage discount to no more than a predetermined dollar amount of purchases.

4. The method according to claim 1, wherein said determining an available percentage discount based on said updated accumulated discount information comprises establishing as said available percentage discount the lesser of said percentage discount and a predetermined capped percentage discount.

5. The method according to claim 1, wherein said existing accumulated discount information comprises a then existing and earned percentage discount and wherein said existing accumulated gallons information comprises a then existing number of gallons purchased but not yet converted into a discount.

6. The method according to claim 1, wherein said predetermined number of gallons is ten gallons and wherein said particular level of discount is one percent.

7. The method according to claim 1, wherein said existing accumulated discount information includes an existing percentage discount, and wherein said determining updated accumulated discount information comprises determining said percentage discount by determining a current earned percentage discount based on said existing accumulated gallons information, said number of gallons purchased and said predetermined number of gallons and adding said current earned percentage discount to said existing percentage discount.

8. The method according to claim 1, wherein said customer has one or more customer identification elements each having said customer identification information associated therewith and wherein said receiving customer identification information comprises obtaining said customer identification information from the one or more customer identification elements.

9. The method according to claim 8, wherein said one or more customer identification elements is a customer card, wherein said customer identification information is provided on said customer card in barcode form, and wherein said receiving customer identification information comprises reading said customer identification information from said customer card.

10. The method according to claim 1, further comprising providing a report to said customer after said storing step, said report being based on said updated accumulated discount information and said updated accumulated gallons information.

11. The method according to claim 10, wherein said report is provided on a receipt provided to said customer at said gas station location.

12. A system for incentivizing a customer to purchase products from a retailer, said customer having customer identification information, comprising:
a main server;
a customer database in electronic communication with said main server, said customer database storing accumulated discount information and accumulated gallons information for said customer in association with said customer identification information, said accumulated discount information and said accumulated gallons information being determined each time said customer purchases a number of gallons of gasoline at a gas station location affiliated with said retailer and said customer identification information is obtained in association therewith, said accumulated discount information comprising a percentage discount and said accumulated gallons information comprising a number of gallons purchased but not yet converted into a discount, said accumulated discount information and said accumulated gallons information, when determined, being based on said number of gallons purchased, existing accumulated discount information and existing accumulated gallons information stored in said customer database in association with said customer identification information, and a predetermined number of gallons required for earning a particular level of discount; and
at least one computing device located at a retailer location of said retailer, said at least one computing device being adapted to receive said customer identification information associated with said customer when said customer purchases retail products at said retailer location, obtain an available percentage discount based on said updated accumulated discount information using said customer identification information associated with said customer, after said available percentage discount is obtained determine from said customer whether said customer elects to use said available percentage discount, and if it is determined from said customer that said customer elects to use said available percentage discount, apply said available percentage discount in connection with said purchase of retail products by said customer.

13. The system according to claim 12, wherein said at least one computing device is adapted to obtain an available percentage by obtaining said updated accumulated discount information from said central location using said customer identification information associated with said customer and determining said available percentage discount based on the obtained updated accumulated discount information.

14. The system according to claim 12, wherein said at least one computing device is adapted to apply said available percentage discount in connection with said purchase of retail products by said customer by applying said available percentage discount to no more than a predetermined dollar amount of purchases.

15. The system according to claim 12, wherein said at least one computing device is adapted to determine an available percentage discount based on said updated accumulated discount information by establishing as said available percentage discount the lesser of said percentage discount and a predetermined capped percentage discount.

16. The system according to claim 12, wherein said at least one computing device comprises a point-of-sale terminal coupled to a retailer computer system.

17. The system according to claim 12, further comprising a pump and a gas station computer system located at said gas station location, said pump being adapted to obtain said customer identification information when said customer purchases said number of gallons of gasoline, said gas station computer system being adapted to receive said customer identification information and said number of gallons purchased from said pump, request and receive said existing accumulated discount information and said existing accumulated gallons information stored in said customer database from said main server, determine said accumulated discount information and said accumulated gallons information based on said number of gallons purchased, said existing accumulated discount information and said existing accumulated gallons information stored in said customer database in association with said customer identification information, and said predetermined number of gallons required for earning a particular level of discount when said customer purchases said number of gallons of gasoline, and provide said accumulated discount information and said accumulated gallons to said main server.

18. The system according to claim 12, wherein said existing accumulated discount information comprises a then existing and earned percentage discount and wherein said existing accumulated gallons information comprises a then existing number of gallons purchased but not yet converted into a discount.

19. The system according to claim 12, wherein said predetermined number of gallons is ten gallons and wherein said particular level of discount is one percent.

20. The system according to claim 12, wherein said existing accumulated discount information includes an existing percentage discount, and wherein said accumulated discount information is determined by determining said percentage discount by determining a current earned percentage discount based on said existing accumulated gallons information, said number of gallons purchased and said predetermined number of gallons and adding said current earned percentage discount to said existing percentage discount.

21. The system according to claim 12, wherein said customer has one or more customer identification elements each having said customer identification information associated therewith and wherein said customer identification information is obtained from the one or more customer identification elements.

22. The system according to claim 21, wherein said one or more customer identification elements is a customer card, wherein said customer identification information is provided on said customer card in barcode form, and wherein said customer identification information is obtained by reading said customer identification information from said customer card.

23. The system according to claim 17, wherein said pump is adapted to provide a report to said customer, said report being based on said accumulated discount information and said accumulated gallons information.

24. The system according to claim 23, wherein said report is provided on a receipt provided to said customer.
